(19) United States
(12) Patent Application Publication
(10) Pub. No.: US 2005/0024488 A1
(43) Pub. Date: Feb. 3, 2005

(54) Distributed immersive entertainment system

(76) Inventor: Andrew S. Borg, Acton, MA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/741,151

(22) Filed: Dec. 19, 2003

Related U.S. Application Data
(60) Provisional application No. 60/435,391, filed on Dec. 20, 2002.

(51) Int. Cl. H04N 7/00; H04N 5/225

(52) U.S. Cl. 348/36; 348/335

(57) ABSTRACT

A multi-camera high-definition or standard-definition switched video signal is distributed from the Point of Capture (POC) using industry standard technology for broadband distribution such as fiber optic or satellite, to a Point Of Display (POD) where multiple video projectors or displays integrated with a digital light show and high-end audio are utilized to provide a totally immersive entertainment environment. That environment is controlled using a graphically based tool called the LightPiano™, and is then extended through the festival atmosphere in the Club Annex, where licensed merchandise, auctions, and swap meets are located. Online Instant Messaging, Short Message System (SMS) text messaging, Chat, and Fan Clubs generate additional content, which is sent back to the POD. There is extensive use of the Worldwide Web for both local and remote access to the chat, fan clubs, SMS and instant messaging systems, as well as for online access for customers to view scheduling, and purchase ticketing, webcasts and archive access. The Web is also used by the venue owner to manage the entire system for booking, data mining, scheduling, ticketing, webcasting, and facilities management. The Web interface combined with the power of the LightPiano makes this complex interrelated system relatively easy and intuitive to operate. It significantly lowers the cost of operation and makes the system scalable to a large network of POCs and PODs. It allows one POC to feed many PODs, enabling a truly global distributed, immersive entertainment environment.

### CROSS-REFERENCE TO RELATED APPLICATIONS

This application claims any and all benefits as provided by law of U.S. Provisional Application No. 60/435,391 filed Dec. 20, 2002, which is hereby incorporated by reference in its entirety.

### COPYRIGHT NOTICE

Copyright, 2002, Hi-Beam Entertainment. A portion of the disclosure of this patent document contains material that is subject to copyright protection. The copyright owner has no objection to reproduction by anyone of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH

Not Applicable

### REFERENCE TO MICROFICHE APPENDIX

Not Applicable

### BACKGROUND OF THE INVENTION

This invention relates to a system for the distribution and display of both live and prerecorded entertainment in an immersive environment and other content to a plurality of sites and more particularly to a system that provides control of said environment. The present invention pertains to the fields of immersive (“virtual” or simulations-based) entertainment and live broadcast.

The invention is directed to a novel distributed entertainment system in which a plurality of participants experience a live or prerecorded performance, educational, business related or other audience participatory event, at a location remote from the site of origination in an immersive sensory environment; and in preferred embodiments it integrates both remote and locally-sourced content creating a group-experienced “virtual” environment which is “neither here nor there”.

In prior popular music performances, complex logistics and a significant expense are required in order to bring large audiences to concert venues to witness or experience live performance. The costs incurred can be significant for the parties involved. For the performing talent and the associated support staff, the costs associated with travel are both financial and emotional. At the venue itself, the cost of producing the show, insurance, and general liability costs are also significant.

There have been attempts to provide simultaneous broadcast of entertainment content to remote sites such as pay-per-view on cable and broadcast television, as well as “closed circuit” viewings of such content as prizefight boxing, off-track betting, and other entertainment. However, these prior attempts have always been limited to the simple presentation of the live action remotely on a single screen, or from a single point of view. Other attempts to distribute live entertainment content to remote locations have begun to take advantage of the emerging digital cinema systems, which are just now being put into place. These systems use broadband telecommunications infrastructure to convey the signal from the Point of Capture to its destination, and are optimized for large-screen projection. However, these systems use the existing theater real estate to present the remote presentation in the common frontal screen (“proscenium”) presentation format, again from a singular point of view, and typically with fixed (“auditorium” or “stadium”-style) seating.

Charles, U.S. Pat. Nos. 6,449,103 and 6,333,826 and Nayar et al, U.S. Pat. Nos. 6,226,035 and 6,118,474 and 5,760,826 describe systems used to capture visual surround images using elliptically distorted mirrors and computer software to reconstruct the panorama from the distortion, permitting the user to navigate the virtual space on a computer display. Charles also details an application of the same concept for display of panoramic images by the use of the same reflector technique that is used for image capture, with projected images. The images are thereby reconstructed at the projector to provide a 360-degree panoramic image, seen from a single point-of-view.

Johnson et al, U.S. Pat. No. 6,377,306, use multiple projectors to create seamless composite images. Lyhs et al, U.S. Pat. No. 6,166,496, disclose a lighting entertainment system that has some cursory similarity to the present invention in that it proposes a system for entertainment applications that uses signals or stimulus to automatically control another stimulus, such as music or sound to automatically control light color or intensity. Katayama, U.S. Pat. No. 6,431,989, discloses a ride simulation system that uses a plurality of projectors at the rear of the interior of the ride casing, used to create one seamless picture displayed on a curved screen.

Furlan et al, U.S. Patent Application No. 20020113555, provide for the use of standard television broadcast signals for the transfer of 360-degree panoramic video frames. The images transferred are computer-constructed super-wide angle shots (i.e. “fish-eye” images) that are reconstructed at the display side to create an image surround, from a single point-of-view similar to Charles discussed above.

Stentz et al, U.S. Patent Application No. 20020075295, relates to the capture and playback of directional sound in conjunction with selected panoramic visual images to produce an immersive experience. Jouppi, U.S. Patent Application No. 20020057279, describes the use of ‘foveal’ video, which combines both high-resolution and low-resolution images to create a contiguous video field. Raskar, U.S. Patent Application No. 20020021418, discloses an automatic method to correct the distortion caused by the projection of images onto non-perpendicular surfaces, known as ‘keystoning’.

Accordingly, it is an object of this invention to provide an improved method and system for presenting live and recorded performances at a remote location.

### SUMMARY OF THE INVENTION

The present invention is directed to a method and system for presenting a live and/or recorded performance at one or more remote locations. In accordance with the invention, a novel distributed entertainment system is provided in which a plurality of participants experience a live or prerecorded performance, educational, business related or other audience participatory event at one or more locations remote from the site of origination in an immersive sensory environment. In accordance with the invention, the system and method integrates both remote and locally sourced content creating a group-experienced “virtual” environment, which is “neither here nor there”. That is, the content experienced at a given location can be a mixture of content captured from a remote location as well as content that is captured or originated locally.

The invention provides a novel way for performers and other communicators to extend the reach of their audience to geographically distributed localities. The inventions enable a performer to play, not only to the venue that he or she is physically located in, but also simultaneously be playing to remote venues. In addition, the invention can provide for the control of this distributed content from within the environment in which it is experienced.

In accordance with the invention, the sensory experience from the site of origination can be extended to the remote site by surrounding the remote site audience with sensory stimuli in up to 360 degrees including visual stimulus from video (for example, multi-display video) as well as computer graphic illustration, light show, and surround audio. The combination of sensory stimuli at the remote site provides for a totally immersive experience for the remote audience that rivals the experience at the site of origination.

The invention facilitates the delivery and the integration of multimedia content such that an individual (a “visual jockey” or “VJ”) can control the presentation at the remote location in a manner similar to that of playing a musical instrument and much the way a disc jockey (“DJ”) ‘jams’ (mixes improvisationally) the pre-recorded music in a night club. In accordance with the invention, a graphically-based user interface can be provided that allows for the control over the presentation of multimedia content through selectively controlling the display and audio environments by an automated program, a semi-automated program and/or a non-highly skilled technical person.

The present invention can incorporate multi-camera switched high definition video capture, integrated on-the-fly with rich visual imagery, surround sound audio, and computer graphics to create a rich multi-sensory (surround audio, multi-dimensional visual, etc.) presentation using multiple projectors and/or display screens with multiple speaker configurations. In addition, the present invention can provide for mixing temporally disparate content (live, pre-recorded, still, and synthesized) ‘on the fly’ at the remote location(s), allowing a local VJ to “play the room”, and provide for a truly compelling, spontaneous, unique, and deeply immersive sensory experience.

The present invention can include four fundamental components. The first component enables the capture of the original performance at the origination site using high definition or high-resolution video and audio. This is referred to as the Point of Capture or POC. The second component is the transmission system that can use commercially available public and private telecommunications infrastructure (e.g. broadband) to convey the signal from the Point of Capture to its destination(s). Any available analog or digital transmission technology can be used to transmit the captured audio and video to the selected destination. The choice of capture and transmission technologies can be selected based upon the anticipated use at the destination. In one embodiment, the signal from the Point of Capture can be encrypted and/or watermarked before being transmitted to its destination(s). A destination itself is termed the Point of Display or POD. For example, the POD might be a nightclub, amphitheater, or other concert environment. The signal that had been transmitted can be decrypted at the POD. The audio signal can be sent to the surround audio system at the POD. The video signal(s) can be sent to multiple video projectors, surfaces or screens, which surround the audience on all (e.g. four) sides of the room. In addition, at the Point of Display, an integrated computer graphic illustration (CGI) light show can be projected onto available surfaces (e.g. the walls, the ceiling and/or the floor). Preinstalled nightclub special effects such as a fog and smoke machine, programmed light shows and laser light shows can also be integrated with the presentation.

The invention can include a third component, a system adapted to control the video, audio, light show and other special effects components through a user interface, such as a graphical user interface, which allows for the Point of Display environment to be controlled. The user interface can take the form of a master control panel. Alternatively, the user interface can enable a user to control the presentation the same way a musical instrument would be controlled. For example, the system can include a LightPiano which allows a VJ to control the presentation in a manner similar to playing a piano, using touch screens, presets, and effects.

The optional fourth component according to the invention can include a downstream distribution system. When permitted by the performing talent or copyright holder, the same signal that is sent to the Point of Display can simultaneously or even in a time-delayed fashion be sent to other channels of distribution. For example, the Point of Display can be, for example, a nightclub or amphitheater concert environment, or similar venue. The downstream distribution system can include a system that supplies content for mass media distribution such as cable television and pay-per-view, in addition to distribution through the nascent digital cinema infrastructure. It can also include publishing and distribution of the same content on digital video/versatile disk or DVD, as well as being recorded to a permanent archival medium for much later use.

### BRIEF DESCRIPTION OF THE DRAWINGS

Although the drawings represent embodiments of the present invention, the drawings are not necessarily to scale and certain features may be exaggerated in order to better illustrate and explain the present invention.

FIG. 1 is a diagrammatic view of the distributed immersive entertainment system of the invention including the following subsystems of the invention, the content capture subsystem or Point of Capture (“POC”), the transmission subsystem, the content display subsystem or Point of Display (“POD”), and the distribution subsystem including the downstream distribution channels.

FIG. 2 is a diagrammatic view of the POD. Present are the basic elements of an interwoven presentation of surround video content, immersive audio, locally-sourced video and computer graphic illustration (“CGI”) light show, as well as other devices for sensory stimulation, such as laser light show and text display, etc.

FIGS. 3, 4, 4a, and 5 show diagrammatic views of the system(s) that can be used to control the Point of Display environment, herein referred to as the LightPiano™.

FIG. 3 illustrates how the LightPiano can be used to configure the performance content at the POD. As is typical of popular music performances, there are discrete sections of the performance interspersed with breaks, typically called a set or musical set. These are the equivalents of an act in a dramatic presentation. Given that this entertainment has a primary focus on music, the term set is used; but when this same invention is used for theatrical presentation, it would be called act. In this example, four different sets are described. LightPiano can be used to control: the POC satellite feed to screen one; three different video feeds to screens two, three and four; a computer graphic light show to screen five; and a laser light show already extant in the room, using the industry-standard ANSAI DMX 512-A protocol. The LightPiano can control each of the elements individually throughout each of the four sets.

FIG. 4 shows an example of how the graphical user interface for the LightPiano can appear. In the center section of the interface, entitled ‘Room Display’, a graphical preview of each of the projection screens and the light shows can be displayed in real time. In the top section of the interface, the Effects and Transitions that can be applied to the Inputs are shown. The first set of Inputs can be found on the left hand side of the interface. The second set of Inputs can be found on the right side of the interface. At the bottom, Memory Banks can be shown. Combinations of effects and transitions to different inputs can be stored to a Memory location, and applied as a compound effect either presently or at a later time. The various controllable elements can be preprogrammed to automatically follow the same sequence of steps, or a random or pseudo-random sequence of steps.

FIG. 4a shows one embodiment of the LightPiano. Here the LightPiano can receive several video inputs, audio inputs, and streaming text processors. It can control the output to several video displays, audio systems, and lighting and special effects systems.

FIG. 5 shows an example of the construction of a compound filter in the LightPiano to apply to Screen One. In this case, Input from a High Definition video source can be Solarized with a Subtle filter applied to a Fade transition at Medium speed, and then combined or compounded with an effect previously stored in Memory Bank One and merged in real time to Screen One.

FIG. 6 shows how, at the POD, the environment can be extended beyond the room in which the video and audio are originally presented. As an example, in a nightclub where the video and audio can be projected in the main room, an adjoining space, hereby called the Club Annex, presents what is called ‘the Festival Atmosphere’. This can be used to recreate at the remote site many of the environmental stimuli that make the site of origination so compelling. In this example, in the Club Annex opportunities are presented to allow for the purchase of presentation-related and licensed merchandise, to auction or swap memorabilia and associated musical items for the performer's fans, and to interact in what are called Cyber Lounges. Cyber Lounges can provide for informal discussion areas where computers equipped with video displays are connected via broadband to the Internet, providing online access to chat rooms, fan clubs, and instant messaging systems that allow the extended fan base and community of interest to develop both online as well as on-location relationships. In one embodiment, the invention can link the text input from the chat, fan clubs, instant messaging, and SMS (Short Message Service) text messages received from SMS-equipped and MMS (Multi-Media Service)—equipped mobile devices, and feed it back to the plasma displays in the main POD room. This provides a feedback loop for the extended audience, not only back to the POD, but potentially back to the POC as well.

FIG. 7 shows how the use of the Internet can extend the physical location of the POD to a virtual online community across the World Wide Web. In this example, the SMS, instant messaging, chat and fan clubs are also accessible offsite via a Web browser. The POC signal can also be viewed via a streaming webcast. This provides an opportunity for online participants to view the POC content, enquire about the scheduling of upcoming events, buy tickets via an e-commerce facility, purchase licensed merchandise and recorded music, participate in auctions and swap meets, and access an archive of previously recorded content.

FIG. 8 shows the Web-based facilities management services, referred to as the “backend”, provided to the owner of the POD facility. In this example, the club owner can manage their facility, access archived content, retrieve demographic information from tickets previously purchased online, mine data from the user base for local marketing and lead regeneration programs, and book content from other POCs for future presentation dates.

### DETAILED DESCRIPTION OF THE PREFERRED EMBODIMENTS

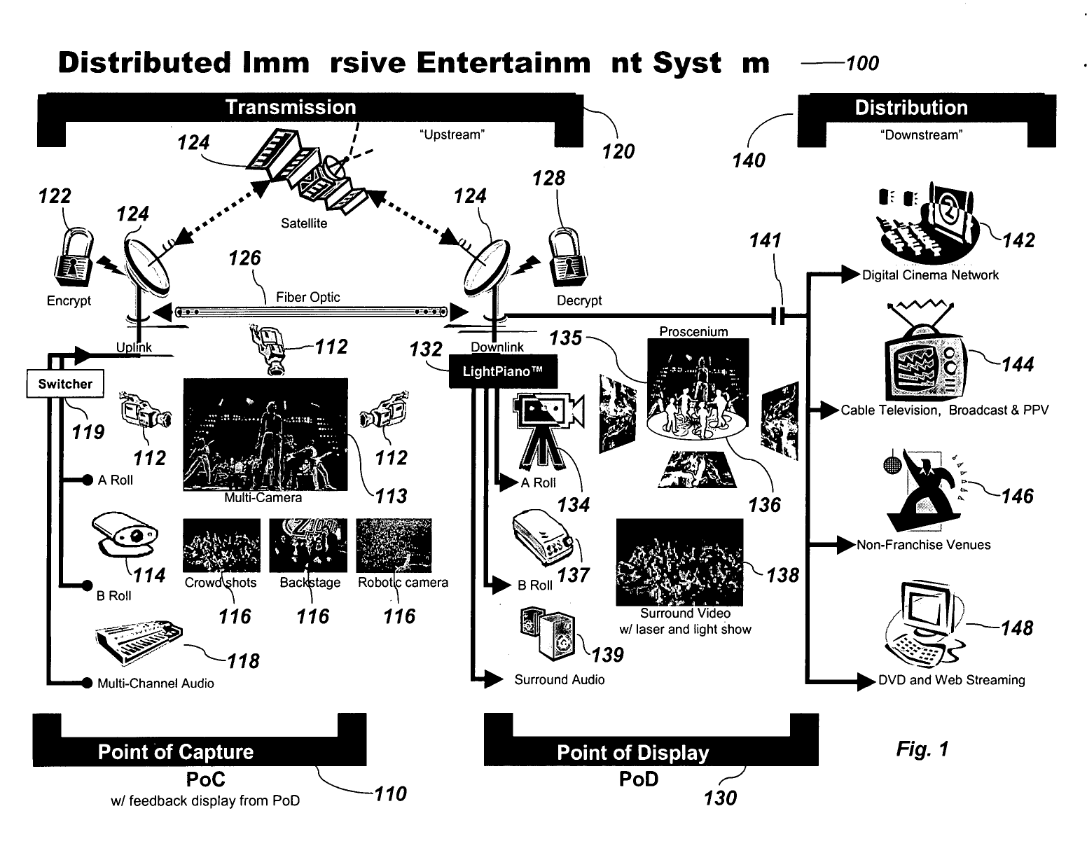

FIG. 1 shows an overview of the primary components of the Distributed Immersive Entertainment System (100) in accordance with the invention. The four primary components in the overview can include: Point Of Capture or POC (110), Transmission (120), Point Of Display or POD (130), and Downstream Distribution (140).

In accordance with the invention, at the POC (110), a system of cameras provides multi-camera video signals (112) of the primary entertainment (113) that can be captured (such as in high definition video) and brought to the video switcher (119) to be switched, or mixed (manually or automatically) as the primary video signal, called here the “A Roll”. In accordance with the invention, the video switcher can be a high-definition video switcher with basic special effects capability. At the same time, the secondary video signals, here called “B Roll” (114), can be captured of environmental scenes, such as the audience or backstage, using roving or robotic cameras (116), and sent to the same video switcher (119).

Multi-channel high quality audio direct from the POC facility's soundboard can be captured (118) and delivered to the switcher (119). The multiple signals of audio and video can be then switched or mixed in the switcher (119), either automatically or manually by an editor or technical director. The completed composite signal ready for POD audience viewing can be then sent via any communication technology, such as a standard broadband delivery system, using the Transmission component (120). In this example, the broadband delivery system can be either fiber optic (126) or satellite transmission (124), although any other appropriate communications technologies can be used. In either case the switched composite signal can be first encrypted (and/or watermarked) (122) for security purposes before being transmitted across the broadband delivery system.

When the signal is received at the Point Of Display or POD (130), the signal can be decrypted (and/or the watermark authenticated) (128) and then sent through the POD projection system which can consist of one or more A Roll projectors or video displays (134) which present the A Roll environment video that can include, for example, a high-definition multi-camera switched shot (136), one or more B Roll projectors (137) to present the B Roll environment video which can display the B Roll on other projection screens (138) or video displays (not shown), and a surround audio system (139) that can provide synchronized audio. All video and audio signals, as well as laser and computer generated light shows as described in later Figures, can be controlled through the LightPiano™ (132), a system that provides a graphically based environment system controller.

The Distribution component (140), can deliver the content downstream (141) through a multiplicity of distribution channels. Examples include a digital cinema network (142), cable television, broadcast, or pay-per-view system (144), non-franchise venues or other display systems that are outside of this network (146), and physical media distribution such as DVD, and Internet distribution through streaming or Webcasting (148).

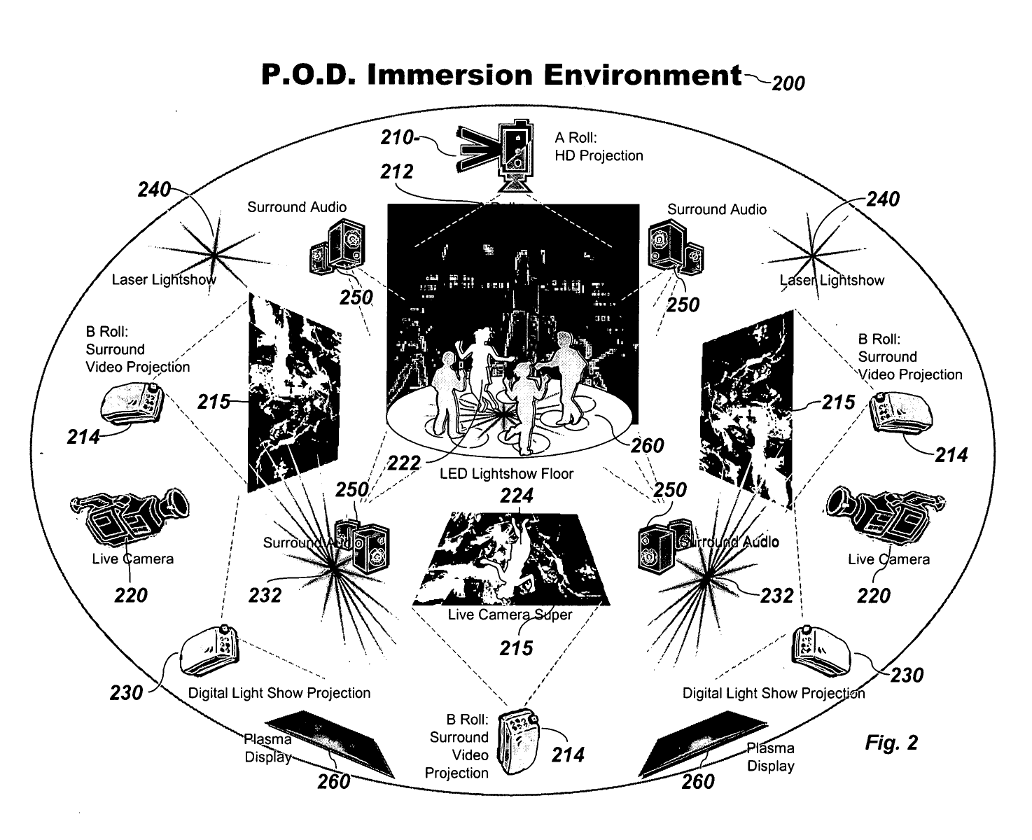

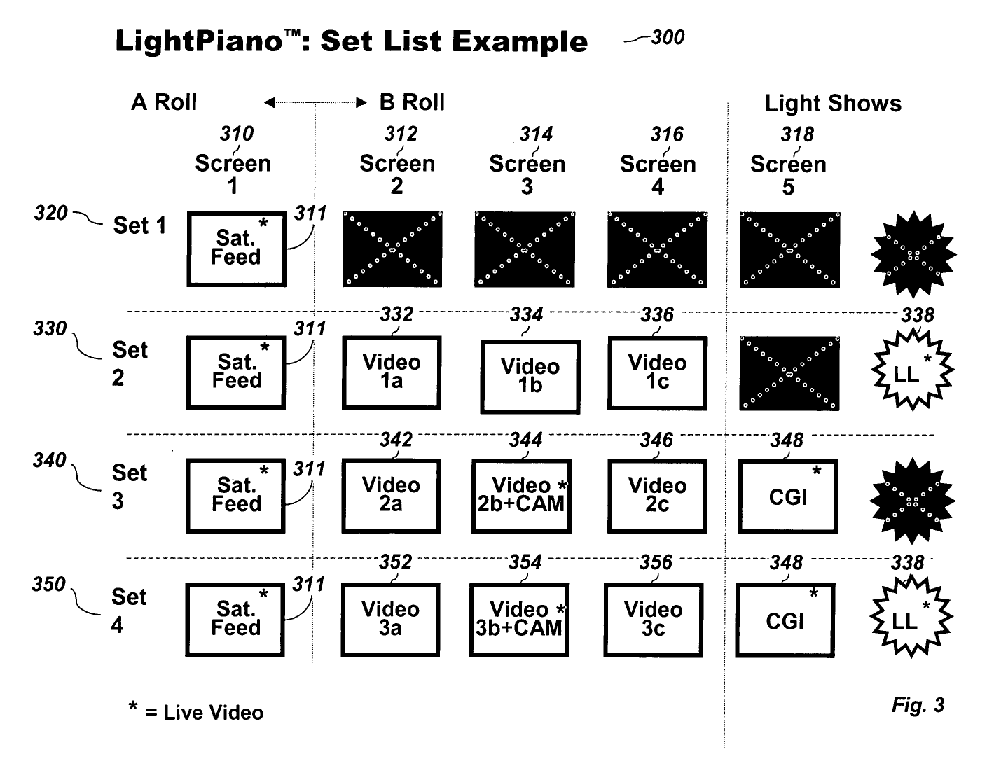

FIG. 2 illustrates the POD immersion environment (200). The A Roll video signal from the satellite or fiber optic transmission system 120, controlled through the LightPiano 132, can be displayed or projected through one or more high-resolution projectors (210) onto one or more primary projection screens, such as Screen One (212). The environmental video can consist of either live or pre-recorded segments projected using, for example, the B Roll surround display system through projectors (214) onto projection screens (215) on the other walls or viewing surfaces of the location. A digital light show generated by computer graphic illustration (CGI) can be projected through the lightshow projector (230) onto an overhead projection screen, or in certain implementations using direct imaging through a light show dance floor (260). The environmental surround video can be intermixed or merged through the LightPiano with live video from the POD captured from a roving camera (220) in the crowd. Already-existing special effects, such as a laser light show (240) can also be controlled by the LightPiano, using the industry-standard DMX digital lighting control protocol. The high quality POC audio signal can be sent to the POD surround audio system (250). Additional input and sensory stimulation such as lightshows and Cyber Lounge text displays can be routed to the plasma displays (260). The POD can also include its own high video cameras (220) that can be used to produce a C Roll at the POD that can be fed back to the POC and broadcast there in order share the remote environments with the local performer and audience FIG. 3 describes an example of a set list for the LightPiano (300) as previously described. In the illustration, there are four rows and six columns. The four rows represent the division of the presentation into four sections correlating to the four musical sets in the example: Set One (320), Set Two (330), Set Three (340), and Set Four (350). The six columns represent the different visual sources for each of the six visual display surfaces in this example. Column 1 (310) represents Screen One, the primary screen (proscenium), where the POC high-resolution switched video can be projected. The second column (312) represents Screen Two, the third column (314) Screen Three, the fourth column (316) Screen Four, and the fifth column (318) Screen Five. Columns five and six represent two different forms of lightshow. Screen Five is the projected computer graphic illustration (CGI) light show. Column six is a laser light show or similar nightclub special effect.

Column one represents the A Roll. Columns two, three, and four represent the B Roll as previously described. The sources marked with an asterisk are live, showing that live sources can be seamlessly integrated with pre-recorded sources as in this example.

Reading across the row from left to right in Set One (320), Screen One shows the switched satellite feed (311), while Screens Two, Three, Four and Five and Laser Light Show (338) are all dark.

In Set Two, Screen One has the same switched satellite feed (311), Screen Two has Video 1A (332), Screen Three has Video 11B (334), Screen Four has Video 1C (336), Screen Five is dark, and a Laser Light Show (338) is on.

The Set Three example has switched satellite feed (311) on Screen One. Screens Two, Three and Four have Videos 2A, 2B and 2C (342, 344, 346) respectively. Screen Five has the CGI lightshow. In addition, Screen Three (344) has also mixed the roving camera live video from the local POD.

Set Four (350) has all systems running. Screen One with satellite feed (311), Screen Two, Three and Four (352, 354 and 356) with Video 3A, 3B and 3C with live camera switched on Screen Three (354). The CGI light show (348) and laser light show (338) are all running simultaneously.

This Figure shows that by using the LightPiano controller, complex multimedia streaming content can be mixed with pre-recorded content in a compelling N-dimensional immersive environment.

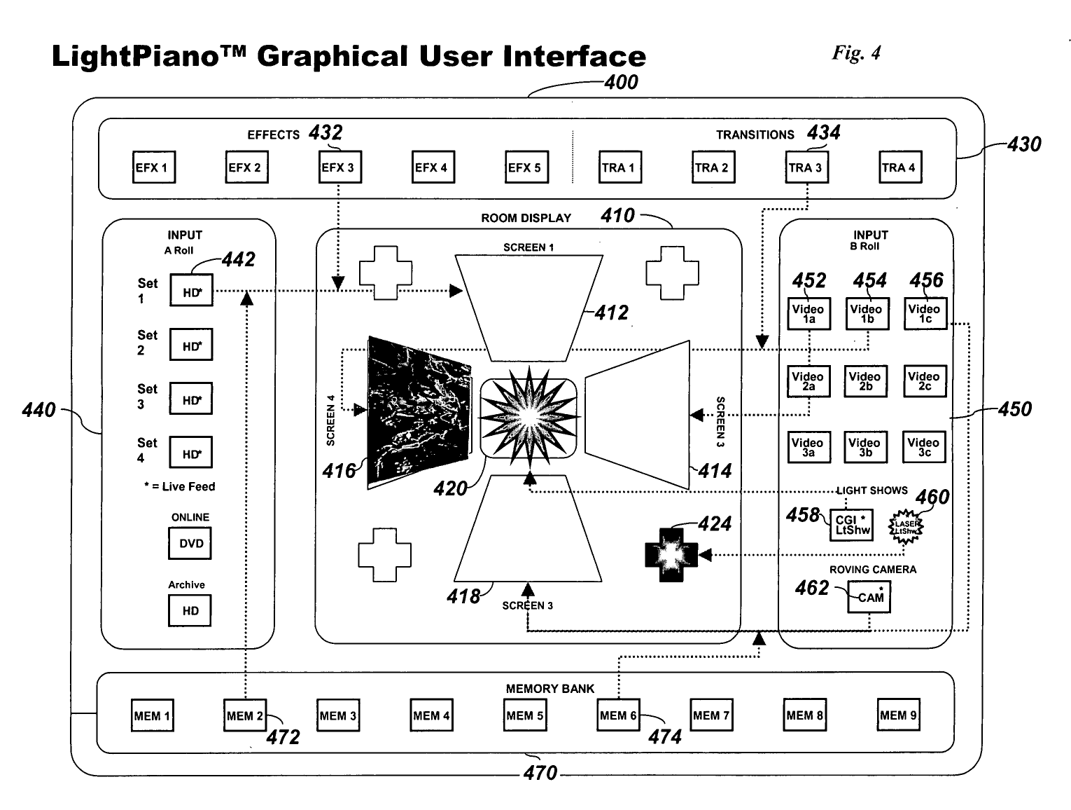

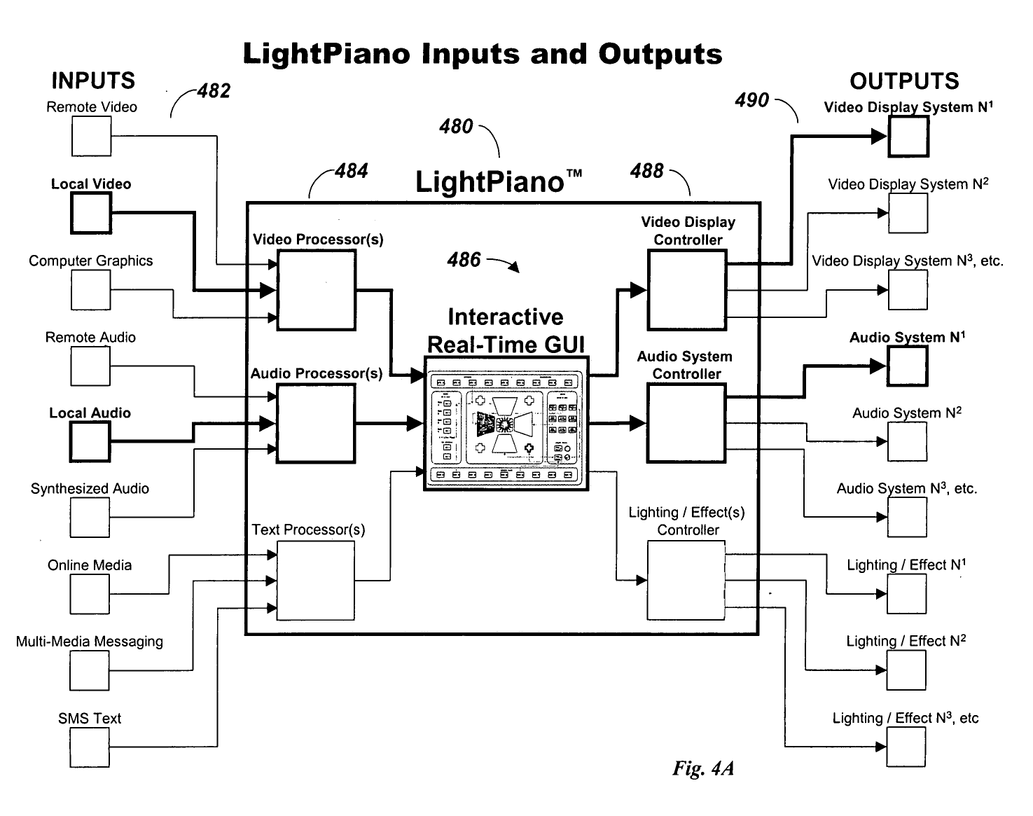

FIG. 4 provides an example of implementation of the graphical user interface of the LightPiano (400). In the illustration the graphical user interface can be visually divided into five discrete sections, for example. At the center of the interface is the Room Display (410), configured for this specific POD installation. This provides a real-time preview of the composite visual affects projected to each screen. For instance, showing what is playing on Screen One (412), Screen Two (414), Screen Three (418), and Screen 4 (416), Screen 5 (420), and the laser light show (424). To the left of the Room Display (410) is the A Roll input (440); to the right is the B Roll input (450). In the top section (430), can be the Effects and Transitions. In the bottom section, compound Effects (or ‘filters’) can be stored in the Memory Bank locations (470). To ‘compose’ the desired surround environment, the icons for the various inputs are dragged and dropped from the various sections of the interface onto the desired Screens in the Room Display (410). In this example, the LightPiano operator drags the icon for A Roll Set 1 (442) onto the position for Screen One (412), while applying Effect 3 (432) to the video signal. This is accomplished by dragging and dropping the Effect icon onto the video path. Screen Two (414) is projecting an unmodified Video B Roll 1A (452). Screen Three (418) has Video B Roll 1C (456) merged with the live roving camera (462) with Memory Bank 6 (474) applied. Screen 4 (416) has Video B Roll 1B (454) with Transition 3 (434).

In accordance with the invention, the complex presentations of high-throughput video, audio, computer graphics, and special effects can be merged in real time and in a intuitive fashion by a non-technical person. By using the LightPiano, the total surround immersive environment can be controlled much like a musical instrument. In the same way that the Moog synthesizer revolutionized the creation of music with the introduction of mechanically synthesized sound, the light piano can fundamentally change the method by which complex visual and audio content can be controlled in a 360° real time environment.

The LightPiano can include a general-purpose computer having one or more microprocessors and associated memory, such as a so-called IBM compatible personal computer, available from Hewlett Packard Company (Palo Alto, Calif.) or an Apple MacIntosh computer available from Apple Computer Company, Inc. (Cupertino, Calif.) interfaced to one or more audio and video controllers to allow the LightPiano to control, in real time or substantially in real time, the presentation of the desired audio and video presentation devices (sound systems, speaker systems, video projectors, video displays, etc.). The general purpose computer can further include one or more interfaces to control, in real time or substantially in real time, the systems that provide various presentation effects (432), such as mosaic, posterize, solarize, frame drop, pixelate, ripple, twirl, monochrome, and duotone. The general purpose computer can further include one or more interfaces to control, in real time or substantially in real time, the systems that provide various presentation transition effects (434), such as jump cut, wipe, fade, spin, spiral out, spiral in, and zoom in. The LightPiano can further include a system for providing memory bank (470) that enables predefined audio and/or video presentation elements optionally with combinations of effects and transitions to be stored and played back. The LightPiano can be adapted to allow a user, such as a VJ, to control the audio and visual presentation of content in real time or substantially in real time.

FIG. 4A shows a diagrammatic view of a LightPiano system (480) according to the present invention. The LightPiano system (480) can include one or more inputs (482) including, for example, remote video, local video, computer graphics, remote audio, local audio, synthesized audio, online media, multimedia messaging and SMS text. Each of the inputs (482) is connected to one or more input processors (484), which allow the input to be processed. Processing can include converting the input signal from one format to another, applying special effects or other processing to the signal and inserting transitions on the input signal. Preferably, the LightPiano system (480) includes a video processor, an audio processor and a text processor. Each input processor (484) is connected to an appropriate output controller (488), which controls the output of the signals to the audio and video presentation output systems (490). Preferably, the LightPiano system (480) includes a video display controller, an audio system controller and lighting effects controller. The video display controller can be connected to a plurality of output video display systems (490), such as display screens and projectors, and can be adapted to control in real time or substantially in real time, the presentation of video on a given output display system. The audio system controller can be connected to a plurality of output audio systems, such as speaker systems and multidimensional or surround sound systems and can be adapted to control in real time or substantially in real time, the presentation of audio on a given sound system. The lighting and effect(s) controller can be connected to a plurality of output lighting and effect(s) systems, such as strobe lights, laser light systems and smoke effect systems and can be adapted to control in real time or substantially in real time, the presentation of the light show and effect(s) by a given lighting or effects system. The LightPiano system (480) can further include a LightPiano graphical user interface (486) adapted to provide a graphical representation as shown in FIG. 4. The LightPiano graphical user interface (486) can be embodied in a touch screen or touch pad that allows a user to drag and drop audio, video and other elements to control the presentation of audio, video, text, lighting, and effects on the various output systems.

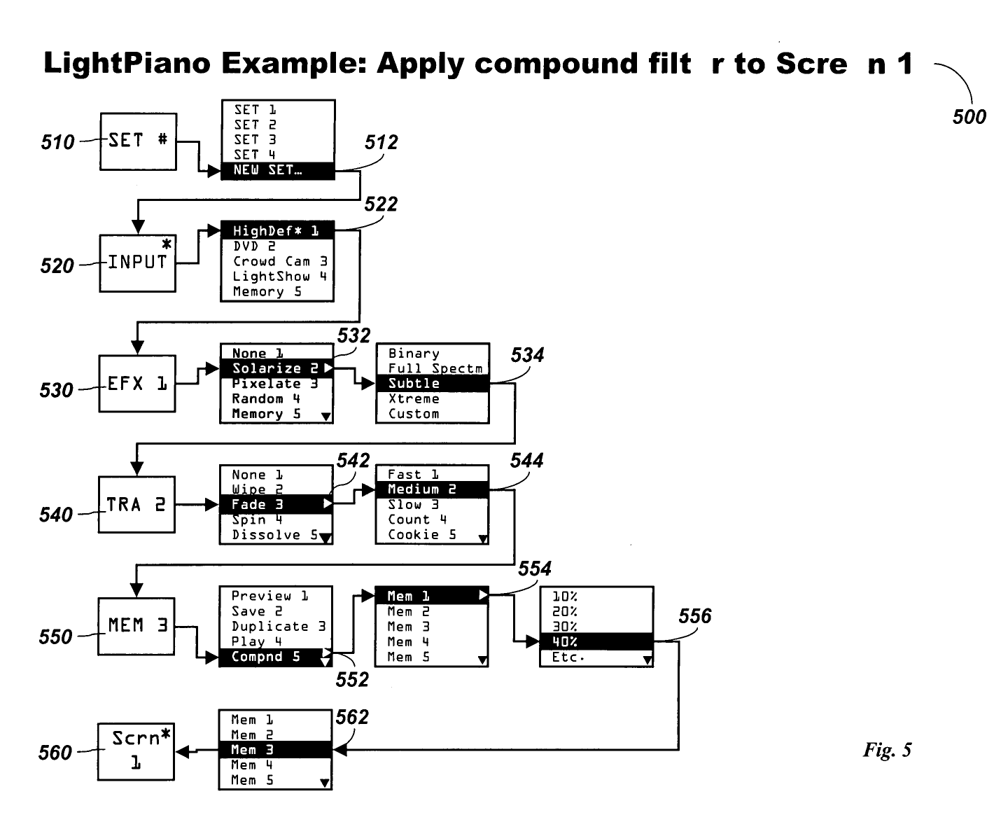

FIG. 5 illustrates an example of applying a compound filter in the LightPiano to Screen One (500). In this flowchart, the user can choose the desired effect in the popup window of the graphical interface that they wish to initiate (510). They select a New Set (512), and then are given the option to select the Input for that New Set (520). The user can select from the choices the High-Definition live feed (522), and apply Effect 1 (530). Effect 1 can be Solarizing filter (532) applied with a pre-set strength of Subtle (534). This can then be applied through a Transition (540) of Fade (542) at Medium Speed (544) that is stored in Memory Bank 3 (550), and then combined (552) with previously stored Memory Bank 1 (554) at a Strength of 40% (556). This can then be stored in new location Memory Bank 3 (562) and played through Screen One (560). Through this example, one can see how highly complex image processing tasks can be setup and automated ahead of time, so that by simply dragging and dropping icons on to the Room Display, very sophisticated special effects can be implemented in real time by a non-technical professional. The LightPiano can provide for the real-time intuitive control of a 360° immersive environment that integrates video, audio, CGI, light show, and other special effects.

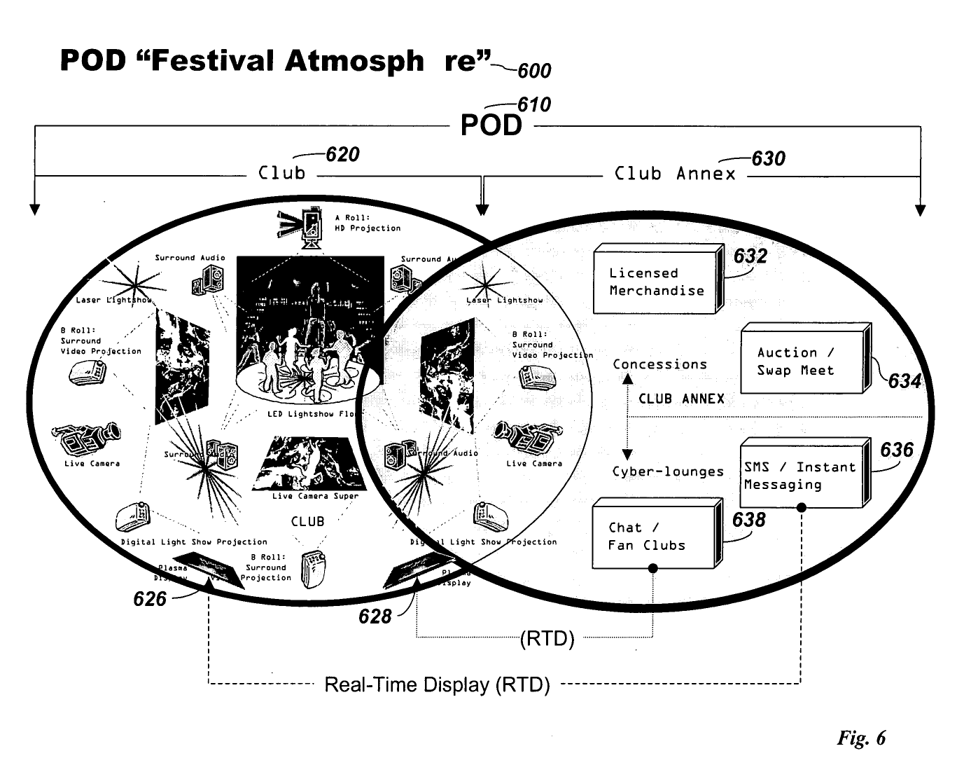

FIG. 6 describes the POD “Festival Atmosphere” Club Annex (600). This can be used to extend the Point of Display environment beyond the main room that contains the video, audio, and light show equipment. In this example, the POD (610) can be divided into the main Club where the equipment resides (620) and the Club Annex (630). The Club Annex can be defined as a usable space outside the main Club room (e.g. the lobby, hallway, special function or VIP room, or lounge). In this example, there can be four activities taking place in the Club Annex (630). Licensed merchandise (authorized by the talent) (632) can be sold in one area; in another, memorabilia, prior recordings, sanctioned bootleg recordings, and other non-licensed merchandise is auctioned or swapped (634).

In an adjoining area can be the Cyber Lounges. These include informal discussion or relaxed seating areas with flat panel displays or laptop computers with a broadband connection to the Internet. This allows for real-time participation in online chat rooms and fan clubs (638). Those with either Short Message System (SMS)-equipped mobile devices (e.g. cell phones) or computer access to instant messaging (e.g. Yahoo or AOL Instant Messager) can send and receive (636) messages from any compatible device. Both the chat and fan club content (638), and the SMS and instant messaging content (636) can then be routed to the Plasma Displays (628) or similar devices in the main Club (620), providing a real-time feedback loop for the extended entertainment environment.

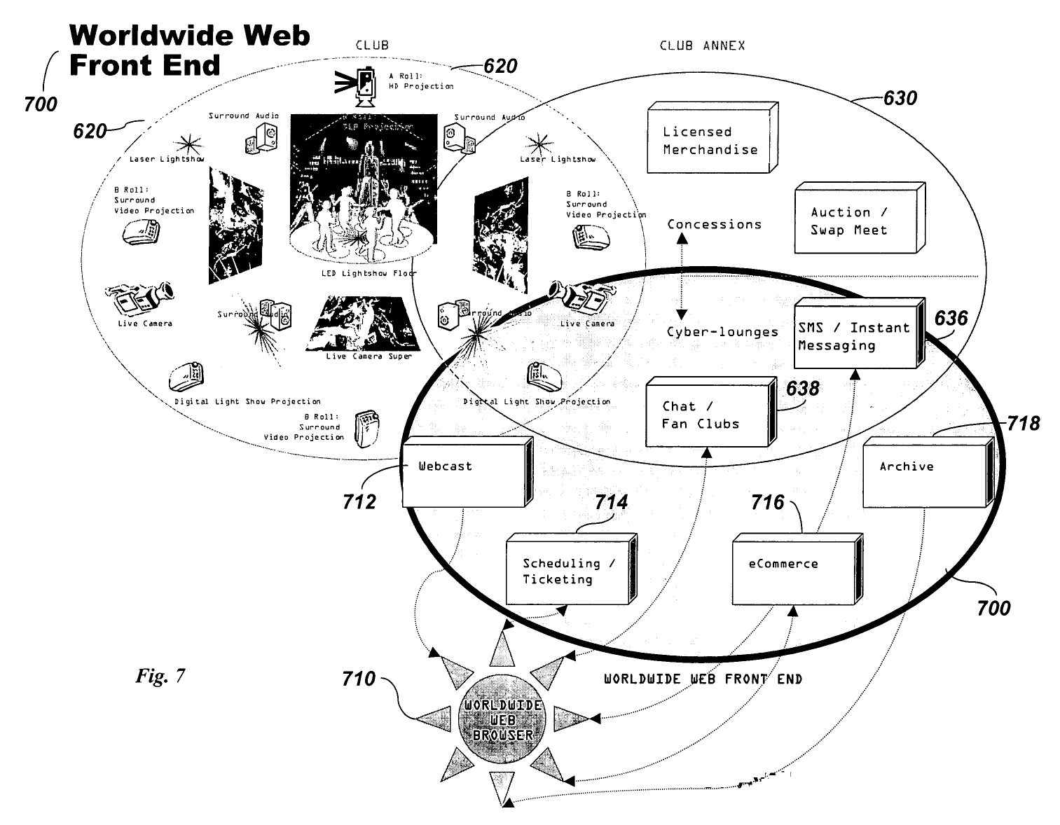

FIG. 7 illustrates how the entertainment environment can then be virtually extended beyond the physical location to the Worldwide Web (700). Those individuals who are not co-located at the POD in either the Club (620) or the Club Annex (630) can participate using a standard Worldwide Web Browser (710). They can take part in the Chat Rooms and Fan Clubs (638), and the SMS and Instant Messaging Environments (636). They can also view webcasts of either live or prerecorded content (712). They can view scheduling information for a local or remote POD, and purchase tickets for future events (714). They can purchase licensed merchandise online, or participate in the auction and swap meets through the system's e-Commerce Engine (716), as well as purchase access to previously recorded content in the Archive (718).

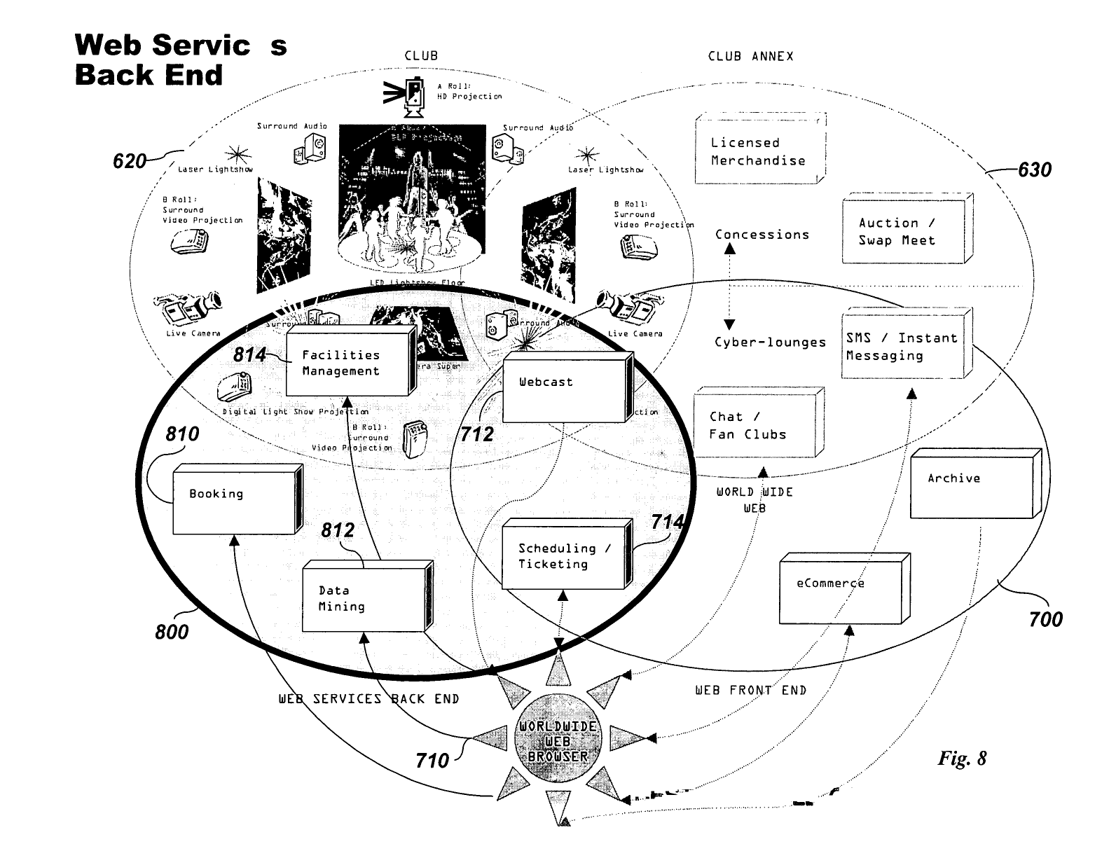

FIG. 8 portrays the Web Services-based backend management system (800) provided to the owner of the venue, which integrates the club (620, the annex (630), the Web front-end (700) and the management system itself (800). Using a Worldwide Web Browser (710)-based interface built on industry-standard Web Services, the club owner can access software services which assist in managing the POD facility (814) for scheduling and ticketing (714), publishing content from this particular location to the Web front-end (712), mining the demographic data from ticketing and fan clubs to generate lead generation and other business development programs (812), and booking future dates for talent broadcast from the immersive entertainment network (810). This then is the final component, in total providing the complete operating environment for an immersive entertainment distribution system.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

1. An immersive entertainment system comprising:
a point of capture system adapted for creating an audio and video signal representative of at least a portion of a performance having audio and video portions;
a transmission system adapted for transmitting said audio and video signal to a predetermined destination; and
a point of display system at said predetermined destination adapted for presenting at least a portion of said audio and video signal, said point of display system including a lightpiano adapted for controlling, in substantially real time, the presentation of said portion of said audio and video signal.

2. An immersive entertainment system according to claim 1 wherein said lightpiano further comprises:
at least one video processor for processing at least one of said video sources to control the presentation of said at least one video source;
at least one audio processor for processing said at least one audio source to control the presentation of said at least one audio source;
at least one video display controller adapted for controlling the display of said at least one video source on at least one video display system; and
at least one audio control system adapted for controlling the presentation of said at least one audio source on at least one audio system.

3. An immersive entertainment system according to claim 2 wherein said lightpiano controls at least one of a remote video input, a local video input and a computer graphics input.

4. An immersive entertainment system according to claim 2 wherein said lightpiano controls at least one of a remote audio input, a local audio input and a synthesized audio input.

5. An immersive entertainment system according to claim 2 wherein said lightpiano controls at least one of an online media input, a multi-media messaging input and an SMS text input.

6. An immersive entertainment system according to claim 2 wherein said lightpiano controls at least one video display system.

7. An immersive entertainment system according to claim 2 wherein said lightpiano controls at least one audio system.

8. An immersive entertainment system according to claim 2 wherein said lightpiano controls at least one lighting and effects system.

9. An immersive entertainment system according to claim 2 wherein said lightpiano includes a graphical user interface adapted for enabling a user to control said at least one video processor, said at least one audio processor, said at least video display controller, and said at least audio system controller.

10. A lightpiano system for controlling the presentation of a performance having a plurality of video sources and at least one audio source, said lightpiano system comprising:
at least one video processor for processing at least one of said video sources to control the presentation of said at least one video source;
at least one audio processor for processing said at least one audio source to control the presentation of said at least one audio source;
at least one video display controller adapted for controlling the display of said at least one video source on at least one video display system; and
at least one audio control system adapted for controlling the presentation of said at least one audio source on at least one audio system.

11. A lightpiano system according to claim 10 further comprising at least one of a remote video input, a local video input and a computer graphics input.

12. A lightpiano system according to claim 10 further comprising at least one of a remote audio input, a local audio input and a synthesized audio input.

13. A lightpiano system according to claim 10 further comprising at least one of an online media input, a multi-media messaging input and an SMS text input.

14. A lightpiano system according to claim 10 further comprising at least one video display system operatively coupled to said lightpiano system.

15. A lightpiano system according to claim 10 further comprising at least one audio system operatively coupled to said lightpiano system.

16. A lightpiano system according to claim 10 further comprising at least one lighting and effects system operatively coupled to said lightpiano system.
